(19) United States
(12) Patent Application Publication
(10) Pub. No.: US 2012/0281863 A1
(43) Pub. Date: Nov. 8, 2012

(54) HEARING AID

(76) Inventor: Kenji Iwano, Kanagawa (JP)

(21) Appl. No.: 13/500,157

(22) PCT Filed: Oct. 12, 2010
(86) PCT No.: PCT/JP2010/006063

§ 371 Date: Apr. 4, 2012

(30) Foreign Application Priority Data
Nov. 4, 2009 (JP) 2009-252609

(51) Int. Cl. H04R 25/00

(52) U.S. Cl. 381/321

(57) ABSTRACT

The hearing aid of the present invention comprises a gain calculation section for calculating the gain for amplifying or compressing an input sound signal, a sound pressure calculation section for calculating an output sound pressure level from the input signal and the gain, a clock section for calculating exposure time by integrating the time intervals at which the output sound pressure level is generated, and an exposure time determination section for detecting whether or not the exposure time for every output sound pressure level has exceeded an allowable time.

### TECHNICAL FIELD

The present invention relates to a hearing aid.

### BACKGROUND ART

There is a conventional hearing aid that has an output sound pressure limiting circuit, which limits the upper register of maximum output sound pressure level characteristics, in order to protect a user from hearing damage caused by excessively loud sounds (see for example, the following Patent Literature 1).

Also, the Japanese Society of Occupational Health has established allowable noise standards aimed at preventing hearing damage caused by excessively loud sounds.

### CITATION LIST

### Patent Literature

Patent Literature 1: Japanese Laid-Open Patent Application H2-58999

### SUMMARY

However, the following problems were encountered with the above-mentioned conventional hearing aid.

Specifically, with the hearing aid disclosed in the above-mentioned publication, when an input sound pressure over a specific threshold is applied, the speech output signal ends up being suppressed right away. Accordingly, there is the risk that conversation will actually be harder to hear, so this hearing aid not as useful as it might be.

### Technical Problem

It is an object of the present invention to provide a hearing aid that is more useful, which prevents hearing damage by having the user or someone else recognize in advance a risk of hearing damage, and which eliminates the problem of conversation and so forth being hard to hear.

### Solution to Problem

The hearing aid of the present invention comprises a gain calculation section, a sound pressure calculation section, a clock section, an exposure time determination section, and a gain limiting section. The gain calculation section calculates the gain for amplifying or compressing of an input sound signal. The sound pressure calculation section calculates an output sound pressure level on the basis of the input signal and the gain. The clock section calculates exposure time by integrating the time intervals at which the output sound pressure level is generated for every output sound pressure level. The exposure time determination section detects whether or not the exposure time for every output sound pressure level calculated by the clock section has exceeded a specific allowable time. The gain limiting section adjusts the gain calculated for each frequency band of the input signal according to the length of the allowable time set in the exposure time determination section.

The term “exposure time” section how long the user is exposed to a specific sound pressure level that poses a risk of hearing damage.

Consequently, whether or not there is a risk of hearing damage can be detected by having the exposure time determination section detect whether or not the exposure time for every output sound pressure level has exceeded an allowable time. Also, control for lowering the risk of hearing damage can be adjusted according to the situation, such as the surrounding environment, for example, by adjusting the size of the gain calculated for each frequency band, according to the length of a preset allowable time. As a result, gain limiting control can be more flexible to suit the situation, and this affords a hearing aid that is more useful.

The hearing aid pertaining to the second invention is the hearing aid pertaining to the first invention, further comprises a frequency analysis section configured to convert the input signal into a frequency-band signal. The gain calculation section calculates the gain for every frequency band of the input signal. The sound pressure calculation section calculates the sound pressure level for every frequency band of the input signal. The clock section calculates the exposure time for every frequency band of the input signal. The exposure time determination section detects whether or not the exposure time for every frequency band of the input signal has exceeded the allowable time.

Consequently, although there will be times when the signal component of a particular frequency band has an extremely large amplitude for one reason or another, such as frequently occurring howling, if the sound pressure level is calculated for every frequency band, and it is detected whether or not the exposure time has exceeded the allowable time for every band, then it can be detected that there is a risk of hearing damage when it is detected that the allowable time has been exceeded for every band.

The hearing aid pertaining to the third invention is the hearing aid pertaining to the second invention, wherein the frequency analysis section converts the input signal into a frequency-band signal of three or more frequency bands.

Here, if the frequency analysis section merely divides into two bands, namely, a speech frequency band and a non-speech frequency band, then there is the risk that even the consonant speech frequency band, which is important for hearing words, will be suppressed even though the sound pressure of the vowel speech frequency band is high, and that words will be hard to hear.

In view of this, with the hearing aid of the present invention, the frequency band is divided into at least three bands.

Consequently, just those sounds whose frequency band is easy to hear are more effectively selected and outputted, which both protects hearing and makes speech easier to hear.

The hearing aid pertaining to the fourth invention is the hearing aid pertaining to any of the first to third inventions, further comprises a notification section configured to notify a hearing aid user or adjuster that the exposure time determination section has detected that the allowable time has been exceeded.

Here, if the exposure time determination section has detected that the allowable time has been exceeded, the user is notified by the notification section by reproducing a notification sound, etc., or the person adjusting the hearing aid is notified when a hearing aid adjustment apparatus connected to the hearing aid displays that the exposure time or allowable time has been exceeded.

Consequently, if the user is alerted to a risk of hearing damage, the user can decide whether to change the settings, etc., in order to prevent hearing damage, or to accept the risk and keep using the hearing aid. Also, if the hearing aid adjuster is alerted, he can recognize a danger of hearing damage when a user comes into a hearing aid shop for hearing aid adjustment, and can decide whether to change the settings, etc., in order to prevent hearing damage, or to accept the risk and keep using the hearing aid.

The hearing aid pertaining to the fifth invention is the hearing aid pertaining to any of the first to fourth inventions, wherein the allowable time includes a first allowable time and a second allowable time that is longer than the first allowable time. The gain limiting section decreases the gain with respect to frequencies outside the speech frequency band out of the gain calculated by the gain calculation section, and outputs an output signal, when the exposure time determination section detects that the first allowable time has been exceeded.

Here, the allowable time for determining the risk of hearing damage is set in steps. If the allowable time that has been set in steps is exceeded, control for reducing the risk of hearing damage is carried out in steps. More specifically, if a first allowable time that is shorter than a second allowable time has been exceeded, the gain is reduced with respect to frequencies outside the speech frequency band.

Consequently, when the exposure time determination section detects that the first allowable time has been exceeded, if the gain is decreased with respect to frequencies outside the speech frequency band out of the gain calculated by the gain calculation section, and an output signal is outputted, then deterioration of phonetic clarity can be suppressed while hearing damage is also suppressed.

The hearing aid pertaining to the sixth invention is the hearing aid pertaining to fifth invention, wherein the gain limiting section decreases the gain with respect to frequencies below 200 Hz or above 6000 Hz out of the gain calculated by the gain calculation section, and outputs an output signal, when the exposure time determination section detects that the first allowable time has been exceeded.

Here, it is assumed that the band from 200 Hz to 6000 Hz is the speech frequency band associated with being able to hear spoken words.

Consequently, if the gain outside the range of this frequency band is decreased and an output signal is outputted, the ease of hearing in the speech frequency band will be maintained so that deterioration of phonetic clarity can be suppressed, while the occurrence of hearing damage can also be suppressed.

The hearing aid pertaining to the seventh invention is the hearing aid pertaining to the fifth or sixth invention, wherein the gain limiting section decreases the gain with respect to frequencies outside the consonant speech frequency band out of the gain calculated by the gain calculation section, and outputs an output signal, when the exposure time determination section detects that the second allowable time has been exceeded.

Here, it is assumed that a person with hearing damage finds it harder to hear consonants than vowels.

Consequently, if the gain with respect to frequencies outside the consonant speech frequency band is decreased and an output signal is outputted, then deterioration of phonetic clarity can be suppressed while hearing damage is also suppressed.

The hearing aid pertaining to the eighth invention is the hearing aid pertaining to the seventh invention, wherein the gain limiting section decreases the gain with respect to frequencies above 200 Hz and below 800 Hz out of the gain calculated by the gain calculation section, and outputs an output signal, when the exposure time determination section detects that the second allowable time has been exceeded.

Here, out of the speech frequency band (a range of approximately 200 Hz to approximately 6000 Hz), the speech frequency band (a range of approximately 800 Hz to approximately 6000 Hz) that does not include a first formant (approximately 200 Hz to approximately 800 Hz), which is the peak frequency of vowels, is the consonant speech frequency band.

Consequently, when the second allowable time has been exceeded, the gain is decreased with respect to frequencies above 200 Hz and below 800 Hz and an output signal is outputted, which allows deterioration in phonetic clarity to be suppressed while hearing damage is also suppressed.

The hearing aid pertaining to the ninth invention is the hearing aid pertaining to any of the first to eighth inventions, wherein the gain limiting section nonlinearly adjusts the gain calculated by the gain calculation section, and outputs an output signal, when the exposure time determination section detects that the allowable time has been exceeded.

Here, word information preferably has a dynamic range of at least 40 dB over the peak minimum audible value of speech.

Consequently, as long as this state can be maintained and the maximum output sound pressure can be lowered, phonetic clarity can be maintained while the risk of hearing damage is reduced by adjusting the gain nonlinearly.

The hearing aid pertaining to the tenth invention is the hearing aid pertaining to any of the first to ninth inventions, wherein the gain limiting section decreases the input sound pressure level of a first knee point at which characteristics switch on a graph of input/output characteristics, while maintaining the dynamic range with respect to the input sound pressure level, when the exposure time determination section detects that the allowable time has been exceeded.

Here, if a dynamic range of at least 40 dB over the minimum audible value cannot be ensured, then hearing protection must be given priority, and the maximum output sound pressure lowered.

Here, with the present invention, a first knee point is decreased, which ensures the dynamic range of input while maintaining phonetic clarity as well as possible, and while allowing the risk of hearing damage to be reduced.

Also, with the hearing aid pertaining to the present invention, the sound pressure calculation section preferably converts to eardrum sound pressure that reflects the frequency characteristics of a sound reproduction section that produces output sound from an output signal. Alternatively, the sound pressure calculation section preferably converts to eardrum sound pressure that reflects the frequency characteristics in the external auditory canal.

Consequently, not just the output sound pressure level in the signal processing section of the hearing aid, but also the sound pressure level at the eardrum can be calculated by adding frequency characteristics that include resonance in the external auditory canal, or output frequency characteristics at a receiver. This makes it possible to determine whether or not hearing damage could occur at an accurate sound pressure level.

Also, with the hearing aid pertaining to the present invention, the sound pressure calculation section preferably converts to eardrum sound pressure that reflects the frequency characteristics in the auditory tube.

Consequently, it is possible to absorb differences due to different hearing aid shapes, and conversion to an accurate eardrum sound pressure can be done with a behind-the-ear model in which the receiver is in the hearing aid main body, or with a behind-the-ear or in-the-ear type of hearing aid with an external auditory canal receiver.

With the hearing aid pertaining to the present invention, measuring in absolute time is preferably used as the clock section.

Consequently, even if the user should turn off the power within one day, the exposure time at the sound pressure level during one day can be accurately measured.

With the hearing aid pertaining to the present invention, measuring in relative time from a specific occurrence time is preferably used as the clock section.

Consequently, there is no need to keep the absolute time in the hearing aid main body, and when the hearing aid is not in use the power can be turned off completely, which reduces power consumption.

With the hearing aid pertaining to the present invention, it is preferable if measuring in relative time from a specific occurrence time is used as the clock section, the absolute time is received from an external control apparatus, and the exposure time is calculated.

Consequently, there is no need to keep the absolute time in the hearing aid main body, and whether power is shut off for a short time or a long time can be determined by converting an absolute time received from an external control apparatus. Thus, the hearing aid main body consumes less power, and hearing protection can be accomplished by calculation of the accurate exposure time.

### Advantageous Effects

With the hearing aid of the present invention, since the exposure time determination section detects whether or not the exposure time for every output sound pressure level has exceeded an allowable time, it can be detected that there is a risk of hearing damage when it is detected that the allowable time has been exceeded. Therefore, hearing damage is prevented before it can happen, situations in which conversation and so forth cannot be heard are prevented, and a more useful hearing aid can be obtained.

### BRIEF DESCRIPTION OF DRAWINGS

FIG. 1 shows the configuration of the hearing aid pertaining to a first embodiment of the present invention;

FIG. 2 shows the configuration of the signal processing section in the hearing aid pertaining to the first embodiment of the present invention;

FIG. 3 is an example of a table of the allowable time and the sound pressure level of the hearing aid pertaining to the first embodiment of the present invention;

FIG. 4 shows the configuration of the signal processing section in the hearing aid pertaining to a second embodiment of the present invention;

FIG. 5 shows the configuration of the hearing aid and the hearing aid adjustment apparatus pertaining to the second embodiment of the present invention;

FIG. 6 shows the configuration of the signal processing section in the hearing aid pertaining to a third embodiment of the present invention;

FIG. 7 is an example of a table of the allowable time and the sound pressure level for each band of the hearing aid pertaining to the third embodiment of the present invention;

FIG. 8 shows the configuration of the signal processing section in the hearing aid pertaining to a fourth embodiment of the present invention;

FIG. 9 is a flowchart showing the flow of processing of the exposure time determination section and the gain limiting section in the hearing aid pertaining to the fourth embodiment of the present invention;

FIG. 10 is an example of a graph of the input/output characteristics of the hearing aid pertaining to the fourth embodiment of the present invention; and

FIG. 11 is an example of a graph of the input/output characteristics of the hearing aid pertaining to the fourth embodiment of the present invention.

### DESCRIPTION OF EMBODIMENTS

### Embodiment 1

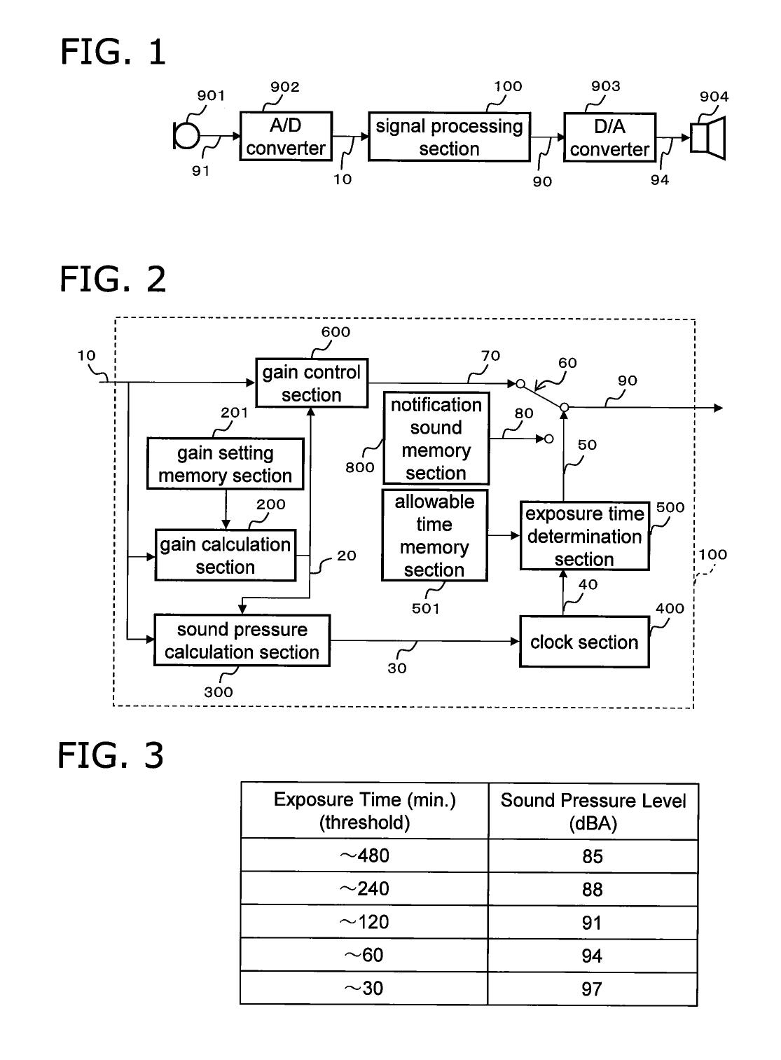

The hearing aid pertaining to the first embodiment of the present invention will now be described through reference to FIGS. 1 to 3.

What are numbered 10, 20, 30, 40, and so on and discussed below are various kinds of signal sent and received between function blocks.

FIG. 1 shows the configuration of the hearing aid pertaining to this embodiment.

As shown in FIG. 1, the hearing aid in this embodiment comprises a microphone 901, an A/D converter 902, a signal processing section 100, a D/A converter 903, and a receiver 904.

The microphone 901 converts input sound into an input analog signal 91. The A/D converter 902 converts the input analog signal 91 into an input digital signal 10. The signal processing section 100 processes the input digital speech signal 10 and produces an output digital signal 90. The D/A converter 903 converts the output digital signal 90 thus produced into an output analog signal 94. The receiver 904 converts the output analog signal 94 into output sound, and reproduces the output sound to the user.

FIG. 2 shows the configuration of the signal processing section 100 in the hearing aid pertaining to this embodiment.

The signal processing section 100 has a gain setting memory section 201, a gain calculation section 200, a sound pressure calculation section 300, a clock section 400, an allowable time memory section 501, an exposure time determination section 500, and a notification sound memory section 800. The gain setting memory section 201 memories the gain 20 according to the hearing level of the user. The gain calculation section 200 calculates the gain 20 with respect to the input digital signal 10. The sound pressure calculation section 300 estimates an output sound pressure level 30 on the basis of the input digital signal 10 and the gain 20. The clock section 400 measures the exposure time 40 with respect to each output sound pressure level 30. The allowable time memory section 501 stores the allowable time of the output sound pressure level for hearing protection. The exposure time determination section 500 determines whether or not the exposure time 40 is within the allowable time with respect to each output sound pressure level. The notification sound memory section 800 stores sounds for conveying determination results.

Next, the flow of processing in the various constituent elements of the signal processing section 100 will be described.

The input digital signal 10 is divided into a specific time segment 1 of processing by the signal processing section 100, and the input digital signal 10 for one specific time segment is inputted to the gain calculation section 200, the sound pressure calculation section 300, and a gain control section 600. The specific time segments 1 can be set as desired. For example, they are set to a time interval of a few milliseconds in which frequency analysis and synthesis processing (discussed below) is performed.

As its initial operation, the gain calculation section 200 reads gain characteristics expressing the relation between the gain and the sound pressure level of the input digital signal 10 according to the hearing level of the user, from the gain setting memory section 201. The gain calculation section 200 then calculates the gain 20 expressing the amplification ratio of the specific time segments 1 to the input digital signal 10, from the sound pressure level of the input digital signal 10 on the basis of the gain characteristics.

The gain control section 600 produces an output sound digital signal 70 by amplifying or compressing by the gain 20 with respect to the input digital signal 10. Here again, from the standpoint of hearing protection, a conventional maximum output limiting circuit (AGC), peak clipping, or the like may be used.

The sound pressure calculation section 300 estimates the output sound pressure level 30 reproduced by the hearing aid on the basis of the gain 20 and the input digital signal 10 of the specific time segment 1.

The clock section 400 calculates, for every output sound pressure level, the time obtained by adding up the time the output sound pressure level 30 has continued (that is, the exposure time) within the time of a specific time segment 2 that is longer than the specific time segment 1.

The “each output sound pressure level” here refers to dividing the output sound pressure level into segments of arbitrary size, but an example will be described in which an output sound pressure level 30 is divided into segments of 3 dB. The specific time segment 2 is an arbitrary time segment. For instance, it may be a day or a week, but an example will be described in which the specific time segment 2 is one day.

FIG. 3 shows the relation between the allowable time and the output sound pressure level 30 at which no hearing loss occurs.

The “allowable time” here expresses the time allowed at which no hearing loss occurs, as the relation between the output sound pressure level 30 and the exposure time 40 with respect to each output level.

The allowable time memory section 501 stores this relation between the allowable time and the output sound pressure level 30.

The term “hearing loss” here includes temporary hearing loss called a temporary threshold shift (TTS) that is subsequently restored, and hearing loss called a permanent threshold shirt (PTS) that is not restored. In this embodiment, “hearing loss” is used in the latter meaning. Also, the allowable time shown in FIG. 3 is an example, and the standard may vary by country or association. If the standards are different, it is possible to use an allowable time that complies with those standards. Also, FIG. 3 shows the relation between allowable time and the output sound pressure level 30 at which no hearing loss occurs, but from the standpoint of preventing hearing loss, it is also possible to break up the allowable time into a plurality of steps.

The notification sound memory section 800 stores a notification sound for alerting the user to the fact that hearing loss may occur. An example of this notification sound is a combination of simple sounds over time, such as “beep beep beep.” With a hearing aid, however, a number of notification sounds are used, such as a sound indicating a change in the volume setting, or a sound indicating a program change, so a sound source must be used that allows the user to distinguish between the different notification sounds. Also, if the hearing aid has sufficient memory capacity, the notification may be verbal, such as using words to convey that “hearing loss may occur at the current output level.” If the notification is given verbally, it is preferable if the language can be selected so that the user can be notified in an understandable language.

The exposure time determination section 500 determines whether or not the exposure time 40 with respect to each sound pressure level is within the allowable time shown in FIG. 3, and calculates an exposure time determination result 50.

If it is determined here that the exposure time 40 with respect to each sound pressure level is within the allowable time, the normal hearing aid operation shown in FIG. 1 is performed, in which the output sound digital signal 70 is switched so as to be outputted as the output digital signal 90, by a switching section (notification section) 60 (see FIG. 2). On the other hand, if it is determined that the exposure time 40 with respect to each sound pressure level has exceeded the allowable time, the switching section 60 performs switching so that a notification sound digital signal 80 is outputted as the output digital signal 90. When reproduction of the notification sound digital signal 80 is complete, switching is again performed by the switching section 60 so that the output sound digital signal 70 is outputted as the output digital signal 90.

This allows the user to learn that there is a risk of hearing loss at the current hearing aid level. Thus, the user can take some action aimed at avoiding a risk of hearing loss, such as changing the settings to lower the gain 20 at the gain calculation section 200, or moving to a quieter environment with less ambient sound. On the other hand, if the user is right in the middle of listening to very important speech, he may decide to continue using the hearing aid without changing the hearing aid settings or the ambient sound environment despite knowing of the risk of hearing loss.

We will now fill in some more details about the clock section 400.

To accurately find the exposure time of an output sound pressure level, it must be measured in absolute time. However, to measure absolute time with a hearing aid, it is necessary to keep consuming power for absolute time measurement even when the hearing aid is not in use, and this is a tradeoff with low power consumption.

In this embodiment, this is dealt with by measuring in relative time at the main body of the hearing aid, and keeping the absolute time with a remote control or an external control device (not shown) that performs volume setting or program setting for the hearing aid. Consequently, the absolute time can be received and converted to clock time on the hearing aid side during communication between the hearing aid and the external control device. As a result, power consumption can be reduced while accurately measuring the exposure time of an output sound pressure level.

### Embodiment 2

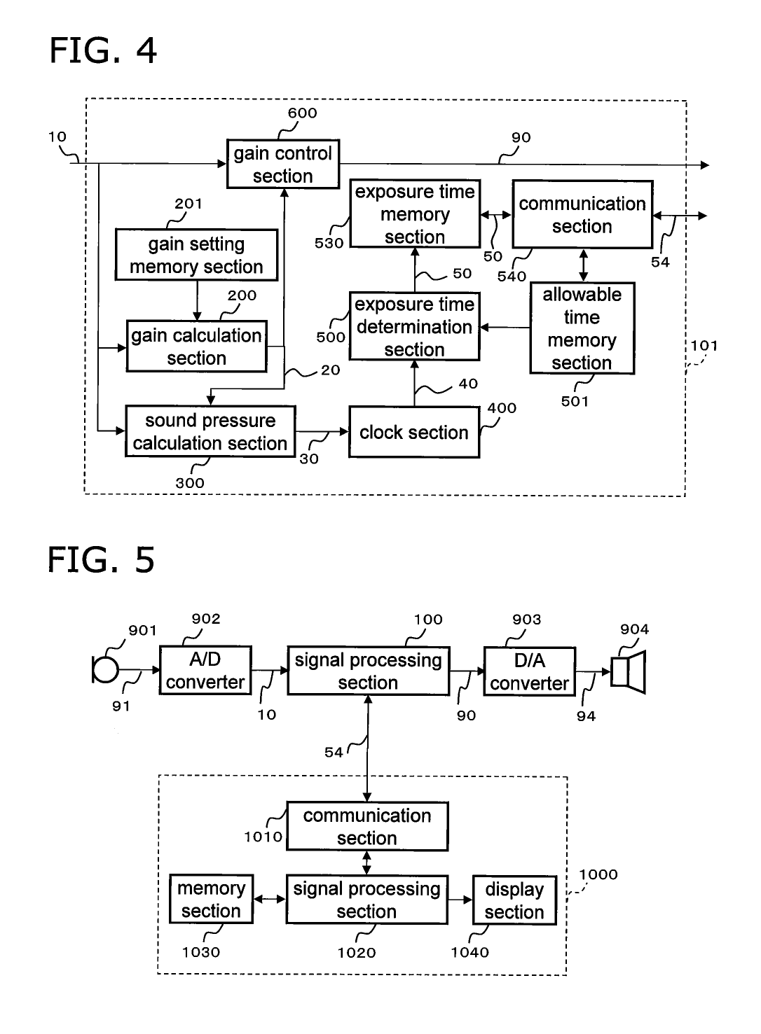

The hearing aid pertaining to another embodiment of the present invention will now be described through reference to FIGS. 4 and 5.

What are numbered 10, 20, 30, 40, 50, 54, and so on and discussed below are various kinds of signal sent and received between function blocks.

FIG. 4 shows the configuration of the signal processing section included in the hearing aid pertaining to the second embodiment of the present invention.

First, the differences between this embodiment and Embodiment 1 above will be described.

In FIG. 1, the user was alerted of the risk of hearing loss by a notification sound, but in FIG. 4, the risk of hearing loss is stored ahead of time in the hearing aid, and this risk of hearing loss is confirmed by a hearing aid adjustment apparatus 1000 during adjustment at the hearing aid shop, etc. Consequently, as a first step the user performs adjustment work called fitting during hearing aid adjustment, but if gain adjustment is performed in the course of this hearing aid adjustment work, hearing loss can be prevented while adjustment intended to improve phonetic clarity can be improved together with a hearing aid expert.

In FIG. 4, those components that are configured the same as in FIG. 1 are numbered the same and will not be described again. What is different in FIG. 4 from FIG. 1 is that exposure time memory section 530 and communication section 540 are provided, and that there is no notification sound memory section 800.

The exposure time determination result 50 in the exposure time determination section 500 is stored in the exposure time memory section 530. The stored time interval may be stored as the time interval of the specific time segment 2 in the exposure time determination section 500, but instead it may be stored in the exposure time memory section 530 only when the exposure time 40 with respect to each output sound pressure level has exceeded the allowable time. This has the effect of reducing memory capacity.

The communication section 540 converts the exposure time determination result 50 into communication data 54 about the exposure time determination result, which is sent to the hearing aid adjustment apparatus 1000. More specifically, the communication section 540 adds an error correction symbol or error detection symbol for performing communication processing. Here, the processing content of the communication section 540 may be decided as desired according to the reliability of the communication path.

FIG. 5 shows the configuration of the hearing aid and the hearing aid adjustment apparatus pertaining to this embodiment.

First, the configuration of the hearing aid adjustment apparatus 1000 will be described.

The hearing aid adjustment apparatus 1000 has communication section 1010 for communicating with the hearing aid, memory section 1030 for storing hearing aid settings, signal processing section 1020 for communicating information related to the settings of the hearing aid or displaying an image, and display section 1040 for displaying information related to the settings of the hearing aid, or the operation of the hearing aid, on a screen for the user or adjuster of the hearing aid.

Next, the flow of processing in the hearing aid adjustment apparatus 1000 will be described.

Communication between the hearing aid adjustment apparatus 1000 and the hearing aid begins when a communication line is connected, or when the hearing aid adjuster inputs a command to begin communication.

The communication section 1010 receives the communication data 54 about the notification section from the hearing aid. The communication section 1010 then decodes any added error correction symbols or error detection symbols and takes out the exposure time determination result 50.

The signal processing section 1020 stores the exposure time determination result 50 in the memory section 1030. The hearing aid adjuster then gives the signal processing section 1020 a command to display the exposure time determination result 50, whereupon the signal processing section 1020 displays the exposure time determination result 50 on the display section 1040.

Consequently, the hearing aid user or adjuster can check this display result and thereby adjust the content of the gain setting memory section 201 of the hearing aid, or the operation of the gain control section 600, via the hearing aid adjustment apparatus 1000. As a result, this adjustment work prevents hearing loss while the hearing aid is adjusted together with a hearing aid expert so as to improve phonetic clarity.

### Embodiment 3

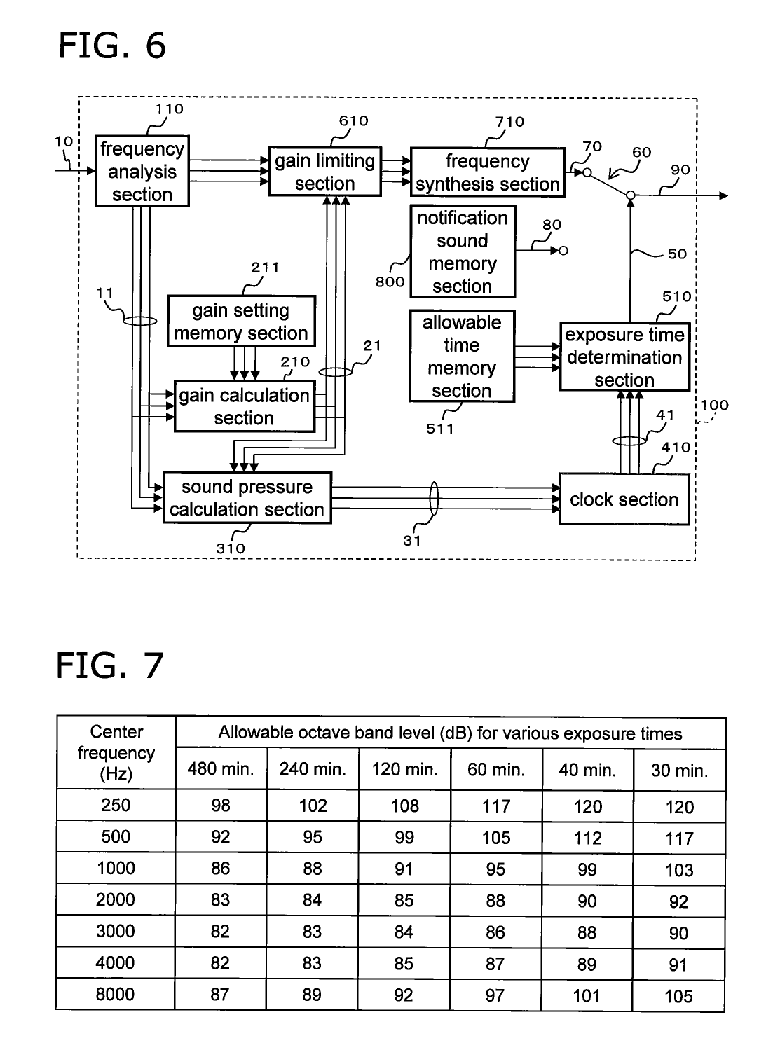

The hearing aid pertaining to yet another embodiment of the present invention will now be described through reference to FIGS. 6 and 7.

What are numbered 10, 11, 21, 31, 41, and so on and discussed below are various kinds of signal sent and received between function blocks.

FIG. 6 shows the configuration of the signal processing section in the hearing aid pertaining to the third embodiment of the present invention. First, the differences between this embodiment and Embodiment 1 above will be described.

In FIG. 1, frequency analysis and synthesis processing was not performed, but in FIG. 6, frequency analysis and synthesis processing is performed, so the risk of hearing loss can be estimated for each frequency band. With sensorineural hearing impairment, damage to the outer hair cells in the cochlea is the first to appear. The operation of the outer hair cells has frequency selection characteristics. Accordingly, hearing impairment can be prevented by estimating the risk of hearing loss for every frequency band as in this embodiment.

In FIG. 6, those components that are configured the same as in FIG. 1 are numbered the same and will not be described again. What is different in FIG. 6 from FIG. 1 is that frequency analysis section 110 and frequency synthesis section 710 are provided, and that each processing is performed for every frequency band.

In this embodiment, the frequency analysis section 110 performs processing in which the input digital signal 10 at the specific time segment 1 is analyzed into an input signal 11 for every frequency band. FFT (fast Fourier transform) is an example of frequency analysis processing.

A gain setting memory section 211 stores gain characteristics for every frequency band, and a gain calculation section 210 calculates a gain 21 for every frequency band.

A gain limiting section 610 subjects the input signal 11 for every frequency band to amplification or compression by the gain 21 for every frequency band.

The frequency synthesis section 710 calculates the output sound digital signal 70 from the output signal for every frequency band.

A sound pressure calculation section 310 calculates an output sound pressure level 31 for every frequency band on the basis of the gain 21 for every frequency band and the input signal 11 for every frequency band.

A clock section 410 calculates an exposure time 41 with respect to each output sound pressure level 31 for every frequency band.

An allowable time memory section 511 stores the allowable time for every frequency band.

FIG. 7 is an example of the relation between the allowable time and the sound pressure level for each band of the hearing aid pertaining to this embodiment.

Here, the allowable time indicated is for when the frequency band is divided to the octave band level.

How the frequency band is divided is not limited to the above method. For instance, just as in FIG. 3, this may be decided as deemed appropriate, taking into account the amount of computation, or meeting standards that vary by country or association. However, the frequency band is preferably divided into at least three parts.

If the frequency band is merely divided in two (a speech band and a non-speech band), then even though the sound pressure is high in the vowel speech band, it will be suppressed to the consonant speech band that is important for hearing words, so it may become harder for the user to hear words. In view of this, the frequency band is divided into at least three parts so as to avoid this problem.

Other examples of how to divide the frequency band will now be described.

For instance, the frequency band may be divided at every critical bandwidth matching a hearing filter, or may be divided to the one-third octave band level that is close to this. This allows the frequency band to be matched to the bandwidth at which loudness is perceived, so hearing protection can be strictly regulated.

Specifically, if this frequency band is divided to the critical bandwidth, or to the one-third octave band level, the gain 21 for every frequency band can be finely controlled by the gain limiting section 610 in the hearing frequency direction. Accordingly, this both protects hearing and maintains a natural output sound.

More specifically, howling may occur with a hearing aid, for example. The input sound when howling occurs is characterized by a narrow frequency bandwidth and by a high sound pressure at that frequency band. To protect the user's hearing from this input sound when howling occurs, it is preferable to perform gain control so as to reduce the gain of sound with a narrow frequency band.

In view of this, when the frequency band at which gain control is performed has a critical bandwidth, howling of the output sound can be suppressed while the effect on other frequency bands can be kept to a minimum.

On the other hand, if the frequency band is divided into at least three parts, such as outside the speech band below approximately 200 Hz, the vowel speech band of approximately 200 Hz to approximately 800 Hz, and the consonant speech band of approximately 800 Hz to approximately 6000 Hz, then hearing protection and word comprehension can both be achieved with a relatively small amount of computation.

An exposure time determination section 510 determines whether the exposure time 41 with respect to each sound pressure level for every frequency band is within the allowable time or has exceeded the allowable time, and sends out the exposure time determination result 50. Specifically, if the exposure time determination result 50 is within the allowable time, the output sound digital signal 70 is outputted as the output digital signal 90. On the other hand, if the exposure time determination result 50 has exceeded the allowable time, the notification sound digital signal 80 is outputted as the output digital signal 90. Processing other than the above is the same as that in FIG. 1, and will therefore not be described again.

We will now fill in some more details about the sound pressure calculation section 300.

In this embodiment, the sound pressure calculation section 300 calculates the output sound pressure level 30 on the basis of the input digital signal 10 and the gain 20. However, from the standpoint of hearing protection, it is important to know not only the output sound pressure of the hearing aid, but also the sound pressure at the user's eardrum. Also, the output signal of the hearing aid is converted with frequency characteristics at the receiver 904 as well, and the frequency characteristics also vary with the shape of the external auditory canal of the user. Furthermore, with a behind-the-ear type of hearing aid, the receiver 904 and the external auditory canal are connected via the auditory tube, and the frequency characteristics at this connected portion must also be taken into account.

Specifically, with the sound pressure calculation section 300, in order to estimate the output sound pressure level 30, the frequency characteristics of the receiver 904, the frequency characteristics of the auditory tube, the ear plug shape (closed or open type), and the frequency characteristics in the external auditory canal of the user are taken into account, and the output sound pressure level 30 is calculated. This affords a more accurate assessment of the risk of hearing loss.

### Embodiment 4

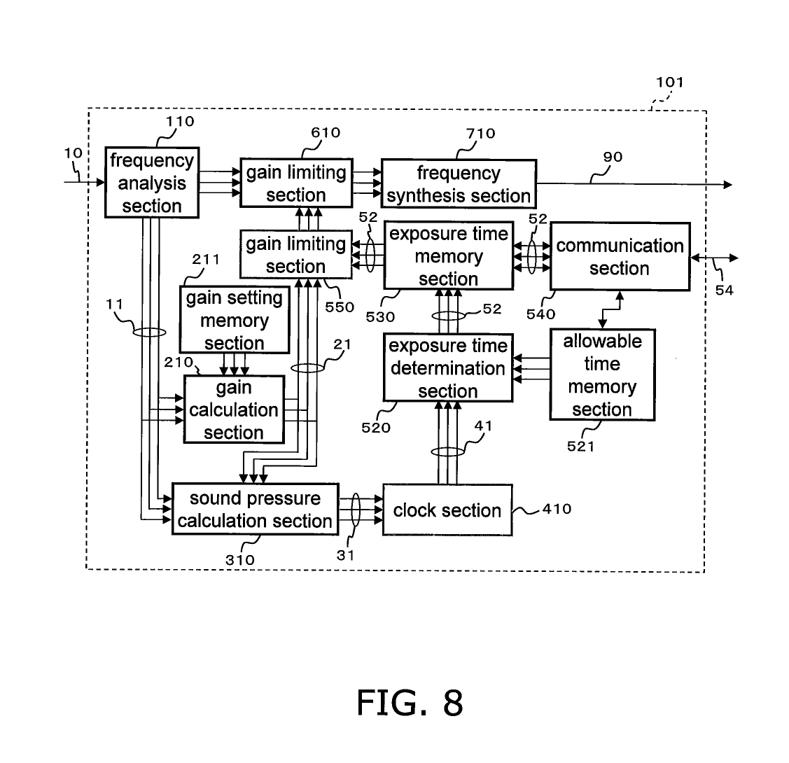

The hearing aid pertaining to yet another embodiment of the present invention will now be described through reference to FIGS. 8 to 11.

What are numbered 10, 11, 21, 31, 41, 52, and so on and discussed below are various kinds of signal sent and received between function blocks.

First, the purpose of the processing performed by the hearing aid in this embodiment will be described.

When the hearing aid user is engaged in work in a sound environment with a high noise level, typified by a construction site or a pachinko parlor or other such gaming establishment, the user is prone to hearing loss due to exposure to noise over an extended period. Although a user such as this spends long periods in environments of high noise level, he must still engage in speech communication with other people through conversation. Specifically, not only does a user who is subjected to extended exposure to noise need to be notified of the risk of hearing loss, but also needs to have his hearing protected by gain limiting in the hearing aid so that hearing loss is not reached, and also needs to be given speech information, with relaxed hearing aid gain limitation, for signals that include speech representing words.

FIG. 8 shows the configuration of the signal processing section in the hearing aid pertaining to this embodiment.

First, the differences between this embodiment and Embodiments 1 to 3 above will be described.

In Embodiments 1 to 3 above, it was an object to notify the hearing aid user and adjuster of the risk of hearing loss. In this embodiment, however, gain limitation processing on the hearing aid side (converting to a gain that is lower than the gain calculated by the gain calculation section) is performed even though the user has not intentionally changed the settings. That is, with the hearing aid of this embodiment, it is an object to lower the risk of hearing loss while extending the length of time that phonetic clarity can be maintained.

In FIG. 8, those components that are configured the same as in FIG. 6 are numbered the same and will not be described again. In FIG. 6, the output digital signal 90 was switched according to the exposure time determination result 50, but in FIG. 8 a gain limiting section 550 is added, and the operation of the gain limiting section 550 is varied according to an exposure time determination result 52. Another difference in FIG. 8 is that the communication section 540 is present, but this is the same as the configuration in FIG. 4 and described for the hearing aid pertaining to Embodiment 2 above, and will not be described again here.

Furthermore, with the hearing aid pertaining to this embodiment, two thresholds, namely, a first allowable time and a second allowable time that is longer than the first allowable time, are provided as the allowable time in which exposure time determination is performed.

The reason here for providing the first allowable time and the second allowable time is that by setting a second allowable time during which the gain of the entire frequency band is limited by giving priority to hearing protection, and a first allowable time during which gain is not limited in the speech band related to being able to hear words, and gain is limited in the frequency bands other than the speech band, the extent to which the output level is suppressed can be clearly distinguished according to the situation, such as the ambient environment of the user.

Thus providing two thresholds, namely, the first allowable time and the second allowable time, allows a natural sound environment to be provided as long as the exposure time is within the first allowable time, while also taking hearing protection into account. When the first allowable time is exceeded, and up until the second allowable time is exceeded, phonetic clarity can be maintained and hearing protected. Further, when the second allowable time has been exceeded, hearing protection can be given the highest priority. As a result, user convenience can be enhanced by adjusting the control by which the risk to hearing protection is reduced according to the situation.

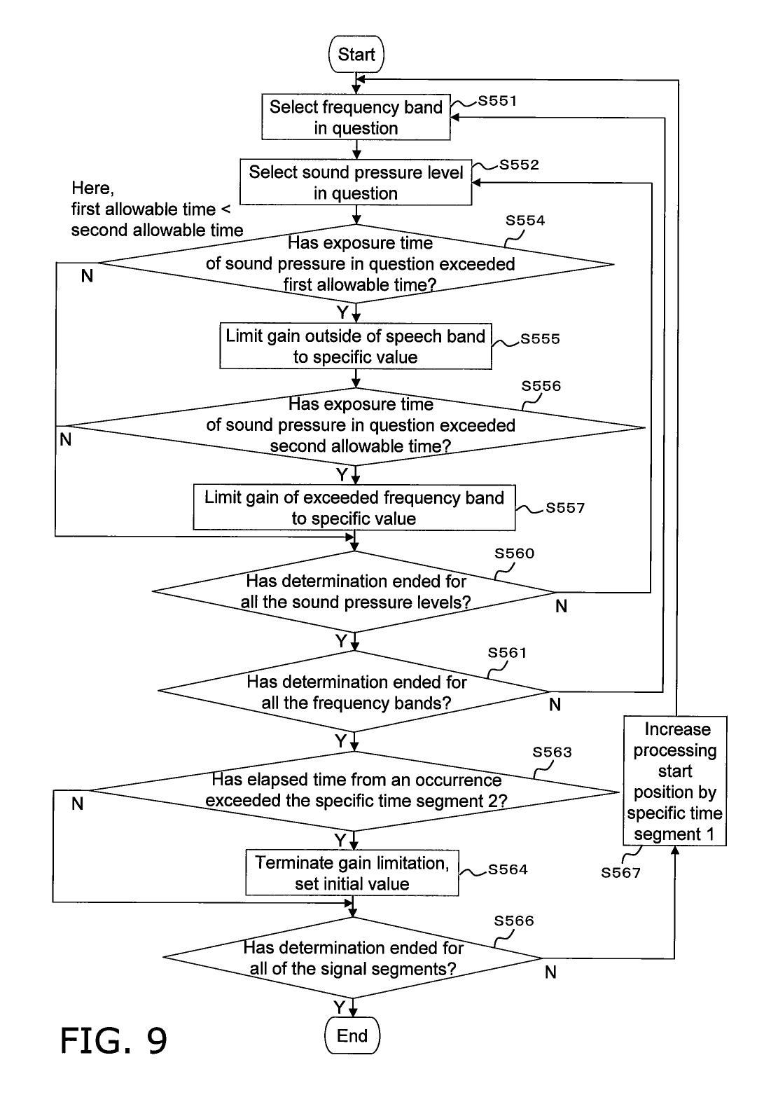

FIG. 9 is a flowchart of the flow of processing of the gain limiting section 550 of the hearing aid pertaining to this hearing aid.

First, the exposure time 41 with respect to each sound pressure level for every frequency band is inputted to an exposure time determination section 520, and then the frequency band in question is selected (S551), as shown in FIG. 9. After this, the sound pressure level in question is selected (S552).

Next, the exposure time 41 of the sound pressure level in question is compared with the first allowable time (S554). Here, if the exposure time 41 is within the first allowable time, the flow proceeds to 5560 and gain limitation processing is not performed. On the other hand, if the exposure time 41 has exceeded the first allowable time, gain limitation processing is performed to limit the gain outside the speech band to a specific value (S555). The “speech band” section the frequency band related to hearing words (see, for example, Kazuoki Kodera, “Hochoki Fittingu no Kangaekata (An Approach to Hearing Aid Fitting),” second revised edition, published by Shindan To Chiryosha, Oct. 7, 2008), and ranges from approximately 200 Hz to approximately 6000 Hz. Next, the exposure time 41 of the sound pressure level in question is compared with the second allowable time (S556). Here, if the exposure time 41 is within the second allowable time, the flow proceeds to 5560 and gain limitation processing is not performed. On the other hand, if the exposure time 41 has exceeded the second allowable time, gain limitation processing is performed on all frequency bands that have exceeded the allowable time (S557). The second allowable time is set as a threshold for the time during which a reduction in hearing could occur, and is set to be longer than the first allowable time.

Next, it is determined whether or not determination has ended for all the sound pressure levels (S560). If all of the determinations have not ended here, the next sound pressure level is selected (S552), and the processing from 5554 to 5557 is repeated.

Next, it is determined whether or not determination has ended for all the frequency bands (S561). If all of the determinations have not ended here, the next frequency band is selected (S551), and the processing from 5552 to S557 is repeated.

Next, since the allowable time for each sound pressure level is decided in the time interval of the specific time segment 2, it is determined whether or not this has been exceeded. Specifically, it is determined whether or not the elapsed time from an occurrence has exceeded the specific time segment 2 (S563). Here, if the elapsed time has exceeded the specific time segment 2, gain limiting control is terminated, and the gain limit is set to the initial value (such as no limit) (S564). On the other hand, if the elapsed time has not exceeded the specific time segment 2, no processing is done and the flow proceeds to 5566.

Finally, it is determined whether or not determination has ended for all of the signal segments (S566). Here, if there is a signal to be temporally processed, that is, if processing is to be continued, the processing start position is increased by the specific time segment 1 (S567), and the flow then returns to 5551 and processing is performed from the start.

At this point the difference between a vowel and a consonant as pertains to words in a speech signal will be described for the purpose of considering how words are heard. Specifically, when a vowel segment and a consonant segment in a speech signal are compared, the consonant segment is characterized by having a smaller amplitude, that is, a lower sound pressure level, and by a shorter duration as well. It can be seen from this characteristic that consonants are what patients often have more trouble hearing.

A phenomenon called masking when a human sound is perceived will now be described. Specifically, there is a phenomenon called frequency masking in which certain sounds are drowned out by other sounds of a similar frequency, and cannot be heard. There is also a phenomenon called time masking in which certain sounds are drowned out by other sounds that are temporally close, and cannot be heard.

In this embodiment, if the exposure time 41 exceeds the first allowable time and is within the second allowable time, gain limitation processing is performed on the input digital signal 10 outside the speech band. In particular, in this embodiment, gain limitation processing is performed on the input digital signal 10 in a low frequency band below 200 Hz, which reduces the effect of frequency masking and time masking with respect to the consonant component of a speech signal. As a result, hearing is protected in a state in which phonetic clarity is maintained with respect to consonants that are harder for a patient to hear.

FIG. 9 shows the flow of processing in which the exposure time determination section 520 and the gain limiting section 550 are combined as two constituent elements. More precisely, the majority of the processing here is done by the exposure time determination section 520, and only steps S555 and S557 involve processing by the gain limiting section 550.

In the above, an example was given in which the first allowable time and the second allowable time were set, so that there were two thresholds, in determining the exposure time. However, the present invention is not limited to this.

For example, in determining the exposure time, three or more steps of allowable time may be set as thresholds. In this case, gain limitation processing can be performed that distinguishes between vowels and consonants.

Specifically, when the allowable time is set in three steps and the exposure time is determined, first gain limitation processing is performed on the input digital signal 10 outside the speech band when the first allowable time is exceeded. Then, when the second allowable time is exceeded, gain limitation processing is performed on the input digital signal 10 outside the consonant band. After this, when a third allowable time is exceeded, gain limitation processing is performed on the input digital signal 10 for all frequency bands. The length of each allowable time shall satisfy the relation first allowable time<second allowable time<third allowable time.

We will now describe the relation between vowel segments and consonant segments in a speech signal for the purpose of maintaining phonetic clarity.

Specifically, since vowels include a component of high sound pressure level in the low frequency band, consonants following vowels are hard to hear due to the effect of frequency masking of the vowels. Furthermore, because consonants following vowels are also affected by the time masking of vowels, they are even harder to hear. Even in a state such as this, a person with normal hearing is able to hear consonants following vowels because of the outer hair cells that selectively amplify the frequency, but with a person whose hearing is impaired due to advanced age, these outer hair cells have frequently been damaged, and frequency masking and time masking make it hard to hear consonants following vowels.

In view of this, with the hearing aid in this embodiment, the gain is limited with respect to vowels, which are easier to hear than consonants.

The consonant speech band here is a speech band that does not include a first formant (approximately 200 Hz to approximately 800 Hz), which is the peak frequency of vowels out of the speech band (a range of approximately 200 Hz to approximately 6000 Hz), and is a frequency band from approximately 800 Hz to approximately 6 kHz. Therefore, gain limitation is performed on everything other than the consonant band by limiting (decreasing) the gain with respect to frequency bands above approximately 200 Hz and below approximately 800 Hz when the elapsed time has exceeded the second allowable time.

The upper limit value of the frequency band in which gain is limited when the elapsed time has exceeded the second allowable time may be set not to approximately 800 Hz, but to a value between approximately 800 Hz and approximately 2000 Hz, leaving a certain interval from the domain of the first formant.

The reason for this is that the optimal upper limit to the frequency band to be the cut-off varies from one individual to the next, depending on the tendency to mis-hear words (hereinafter referred to as confusion), the hearing ability level, and the type of hearing ability (such as a gradually sloping audiogram, a precipitously sloping audiogram, a low-tone impairment audiogram, a horizontal audiogram, a peak audiogram, and a valley audiogram).

For instance, with a user for which the vowel second formant is approximately 800 Hz to approximately 2500 Hz and who tends to confuse not just consonants but vowels as well, the upper limit value for the band is preferably set to 800 Hz so that the user can hear the second formant frequency. Meanwhile, with a user who tends not to confuse vowels but does tend to confuse consonants, it is better to set the upper limit value for the frequency band higher so as to reduce the effect of masking by vowels on consonants. Specifically, when the second allowable time has been exceeded, the gain with respect to the frequency band under the upper limit value and between approximately 800 Hz and approximately 2000 Hz, and above approximately 200 Hz, may be limited (decreased).

If gain limitation processing of the low frequency component below 200 Hz is performed as the band outside the speech band, this reduces the effect of frequency masking on the high frequency band component by the low frequency band component, and that of time masking on following consonants by preceding vowels. Thus, the ability of the user to hear consonants is effectively improved. Furthermore, if gain limitation processing of the frequency band below 800 Hz is performed as the band outside the consonant band, this reduces the effect of both frequency masking and time masking, and further improves the user's ability to hear consonants.

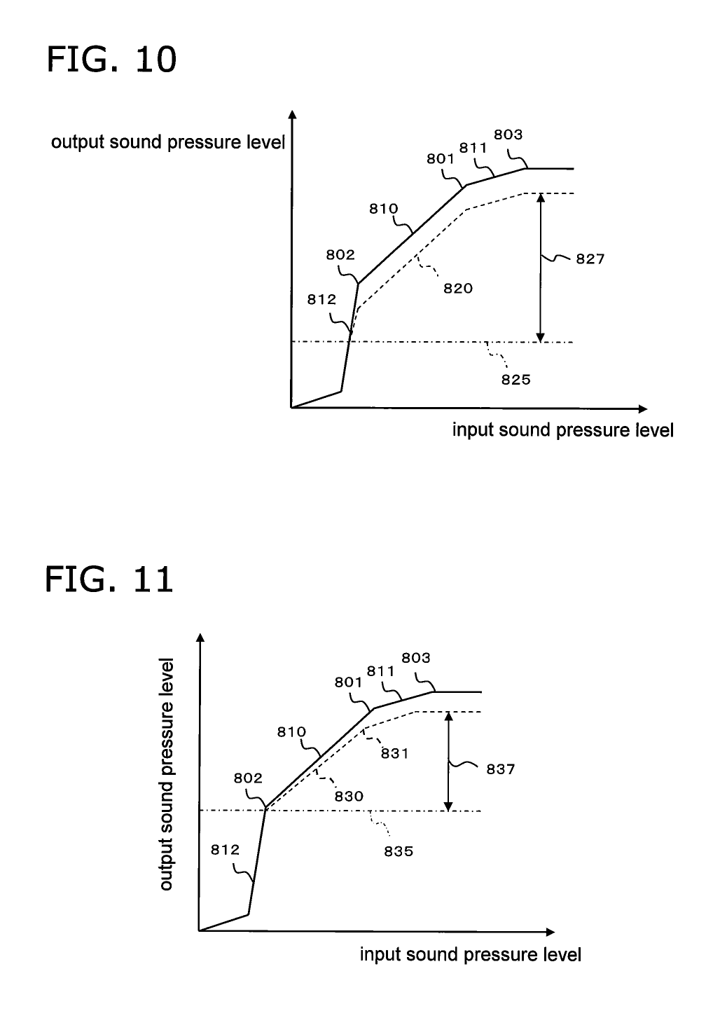

FIG. 10 shows an example of input/output characteristics of the hearing aid pertaining to this embodiment.

These input/output characteristics are set by the hearing aid adjuster using the hearing aid adjustment apparatus 1000, and stored in the gain setting memory section 211, but with the hearing aid pertaining to this embodiment, a method will be described for limiting gain when the input/output characteristics can be varied at the gain limiting section 550.

In the input/output characteristics shown in FIG. 10, the solid line represents before gain limitation, and the broken line after gain limitation.

First, the characteristics of the solid line will be described.

The points at which the characteristics change nonlinearly are a first knee point 801, a second knee point 802, and a point 803 at which the maximum output sound pressure level is reached. In between the first knee point 801 and the second knee point 802 is a linear region 810 that contributes to hearing words. Meanwhile, between the first knee point 801 and the point 803 at which the maximum output sound pressure level is reached is a compression region in which the output sound pressure is limited. Below the second knee point 802 is a squelch region (or expansion region) in which quiet noise is suppressed by wearing the hearing aid.

A minimum audible value 825 is also shown as the quietest sound that the user can hear.

The input/output characteristics shown in FIG. 10 vary with every frequency band, but an example of one frequency band will be described here.

To improve phonetic clarity, there is a need for a dynamic range 827 of at least 30 dB, and preferably 40 dB, from the minimum audible value 825 (see, for example, Kazuoki Kodera, “Hochoki Fittingu no Kangaekata [An Approach to Hearing Aid Fitting],” second revised edition, published by Shindan To Chiryosha, Oct. 7, 2008). Specifically, with the gain limiting section 550, the dynamic range 827 needs to be at least 30 dB, and preferably 40 dB, even after gain limitation processing has been performed.

FIG. 10 shows a case in which an adequate dynamic range has been ensured in the input/output characteristics after gain limitation processing, and the broken line represents the input/output characteristics after gain limitation processing.

With the characteristics shown in FIG. 10, a linear region 820 is parallel to the linear region 810 prior to gain limitation processing. Consequently, hearing can be protected without affecting the ability to hear words, even after gain limitation processing.

FIG. 11 shows a case in which an adequate dynamic range can not be ensured in the input/output characteristics after gain limitation processing, and just as in FIG. 10, the broken line represents the input/output characteristics after gain limitation processing.

For example, as hearing impairment progresses to the point that the user has a high minimum audible value 835, there is the risk that an adequate dynamic range 837 cannot be ensured after gain limitation processing if the minimum audible value 835 is high. In this case, the proper dynamic range of the input sound pressure level can be ensured by lowering the input sound pressure level of a first knee point 831 after gain limitation processing to below the first knee point 801 prior to gain limitation processing.

In some cases, the linear region 830 after gain limitation processing will be characteristics close to those of a compression region. Also, if a decrease in phonetic clarity is seen merely by lowering the first knee point, then the settings may be changed (not shown) to raise the second knee point. Here again, phonetic clarity can be improved.

### INDUSTRIAL APPLICABILITY

With the hearing aid of the present invention, the exposure time determination section detects whether or not the exposure time for every output sound pressure level has exceeded the allowable time, which makes it possible to detect that there is a risk of hearing damage when it is detected that the allowable time has been exceeded, so hearing damage can be prevented before it happens, and the hearing aid is easy to use, so it can also be widely applied to music reproduction devices such as an MP3 player.

### REFERENCE SIGNS LIST

10 input digital signal
11 input signal
20 gain
21 gain
30 output sound pressure level
31 output sound pressure level
40 exposure time with respect to each sound pressure level
41 exposure time
50 exposure time determination result
54 communication data about exposure time determination result
60 switching section (communication section)
70 output sound digital signal
80 notification sound digital signal
90 output digital signal
91 input analog signal
94 output analog signal
100 signal processing section
110 frequency analysis section
200 gain calculation section
201 gain setting memory section
210 gain calculation section
211 gain setting memory section
300 sound pressure calculation section
400 clock section
500, 510, 520 exposure time determination section
501, 511, 521 allowable time memory section
530 exposure time memory section
540 communication section
550 gain limiting section
600, 610 gain control section
710 frequency synthesis section
800 notification sound memory section
801 first knee point
802 second knee point
803 maximum sound pressure gain
810 linear region of input/output characteristics
820, 830 linear region
825, 835 minimum audible value
827, 837 dynamic range
831 first knee point after gain limitation
901 microphone
902 A/D converter
903 D/A converter
904 receiver
1000 hearing aid adjustment apparatus
1010 communication section
1020 signal processing section
1030 memory section
1040 display section

1. A hearing aid, comprising:
a gain calculation section configured to calculate the gain for amplifying or compressing an input sound signal;
a sound pressure calculation section configured to calculate an output sound pressure level on the basis of the input signal and the gain;
a clock section configured to calculate exposure time by integrating the time intervals at which the output sound pressure level is generated for every output sound pressure level;
an exposure time determination section configured to detect whether or not the exposure time for every output sound pressure level calculated by the clock section has exceeded a specific allowable time; and
a gain limiting section configured to adjust the gain calculated for each frequency band of the input signal according to the length of the allowable time set in the exposure time determination section.

2. The hearing aid according to claim 1,
further comprising a frequency analysis section configured to convert the input signal into a frequency-band signal,
wherein the gain calculation section calculates the gain for every frequency band of the input signal,
the sound pressure calculation section calculates the sound pressure level for every frequency band of the input signal,
the clock section calculates the exposure time for every frequency band of the input signal, and
the exposure time determination section detects whether or not the exposure time for every frequency band of the input signal has exceeded the allowable time.

3. The hearing aid according to claim 2,
wherein the frequency analysis section converts the input signal into a frequency-band signal of three or more frequency bands.

4. The hearing aid according to claim 1,
further comprising a notification section configured to notify a hearing aid user or adjuster that the exposure time determination section has detected that the allowable time has been exceeded.

5. The hearing aid according to claim 1,
wherein the allowable time includes a first allowable time and a second allowable time that is longer than the first allowable time, and
the gain limiting section decreases the gain with respect to frequencies outside the speech frequency band out of the gain calculated by the gain calculation section, and outputs an output signal, when the exposure time determination section detects that the first allowable time has been exceeded.

6. The hearing aid according to claim 5,
wherein the gain limiting section decreases the gain with respect to frequencies below 200 Hz or above 6000 Hz out of the gain calculated by the gain calculation section, and outputs an output signal, when the exposure time determination section detects that the first allowable time has been exceeded.

7. The hearing aid according to claim 5,
wherein the gain limiting section decreases the gain with respect to frequencies outside the consonant speech frequency band out of the gain calculated by the gain calculation section, and outputs an output signal, when the exposure time determination section detects that the second allowable time has been exceeded.

8. The hearing aid according to claim 7,
wherein the gain limiting section decreases the gain with respect to frequencies above 200 Hz and below 800 Hz out of the gain calculated by the gain calculation section, and outputs an output signal, when the exposure time determination section detects that the second allowable time has been exceeded.

9. The hearing aid according to claim 1,
wherein the gain limiting section nonlinearly adjusts the gain calculated by the gain calculation section, and outputs an output signal, when the exposure time determination section detects that the allowable time has been exceeded.

10. The hearing aid according to claim 1,
wherein the gain limiting section decreases the input sound pressure level of a first knee point at which characteristics switch on a graph of input/output characteristics, while maintaining the dynamic range with respect to the input sound pressure level, when the exposure time determination section detects that the allowable time has been exceeded.

11. The hearing aid according to claim 1,
wherein the sound pressure level is an eardrum sound pressure.
